(19) United States
(12) Patent Application Publication
(10) Pub. No.: US 2004/0132373 A1
(43) Pub. Date: Jul. 8, 2004

(54) Filter cloth

(76) Inventors: Hans Rudolf Müller, (US); Christoph Maurer, Z?uuml;rich (CH)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/468,594

(22) PCT Filed: Dec. 20, 2001
(86) PCT No.: PCT/EP01/15124

(30) Foreign Application Priority Data
Feb. 20, 2001 (EP) 01104051.6

(51) Int. Cl. B32B 3/00; B32B 5/02; B32B 9/00; D03D 15/00; D03D 25/00; D04H 1/00; D04H 3/00; D04H 5/00; D04H 13/00

(52) U.S. Cl. 442/328; 442/327; 442/332; 442/333; 442/361; 442/59

(57) ABSTRACT

The invention relates to a filter cloth for a filter, which has a supporting surface, comprising a fixing area for attachment to the filter and a filtration area for resting on the supporting surface. In order to raise the filtration area from the supporting surface an extensible fabric structure is provided at least in the filtration area, with highly elastic monofilament threads being selectively incorporated into the fabric structure at least in the filtration area in order to produce a defined amount of elasticity.

The invention relates to a filter cloth for a filter according to the preamble of claim 1 and to a filter bag for a disk filter according to claim 9.

A filter cloth according to the preamble has a fixing area for attachment to the filter and a filtration area for resting on a supporting surface of the filter.

Such a filter cloth is employed for example in vacuum and pressure disk filters that are used for the liquid-solid separation mainly in ore and mineral mines, for instance for refining processes.

In a disk filter a plurality of disks are arranged on a tubular axis, which are each divided into a plurality of segments with cavities. These segments are covered with substantially trapezoidal bags of filter fabric through which the liquid-solid separation takes place. During the operation the filter disks are immersed up to approximately one third of their diameter in a suspension that is to be filtered and may be contained for instance in a tank, a tub or a trough. The filter disks can be rotated gradually or continuously by means of the tubular, hollow axis. The cavities of the individual disk segments of a filter disk are connected to each other and a vacuum is applied thereto during the operation. The vacuum causes the suspension fluid to pass from the tank into the cavities, while a proportion of the solid matter in the suspension to be filtered is retained by the filter fabric and forms a so-called filter cake. The proportion of liquid of the suspension, which has passed through the filter fabric, is remove from the filter by a pump.

In a continuous operation the filter cake must be detached gradually or continuously from the filter fabric, since the solid matter would otherwise be reconveyed into the suspension reservoir. It is known that this detachment of the filter cake is effected by means of a stripper arranged on the periphery of the filter cloths. However, in most cases this leads to a very strong mechanical stress of the filter cloth. For example roughenings can be caused by the mechanical contact of a stripper with the filter fabric, which foster a clogging of the filter fabric as a result of the inclusion of small particles and therefore lead to a progressive loss in efficiency of the filter cloth.

It is also known that the filter cloth is provided in one or several directions with threads that are particularly stable, for example metal wires too, in order to protect the filter cloth against mechanical stress occurring during the stripping process. However, the effort involved in the production of such filter cloths is increased considerably through this and consequently their costs too.

Another known and basically different method for detaching the filter cake from the filter cloth in a disk filter is to interrupt the vacuum in a filter disk segment in a particular angular position and to blow the filter cake off the filter cloth by means of a blast of air. The blown off solid matter can be collected by a funnel and removed from the filter by means of suitable devices.

If a filter disk rotates for instance in the clockwise direction, the filter cake must be detached from the disk at an angular position corresponding to the time of “three o'clock”, as the solid matter would otherwise be reconveyed into the suspension reservoir. To this end the vacuum is interrupted for example at the angular position of “three o'clock” and air is blown into the filter disk segment. Through the blast of air the filter cake is detached from the filter cloth, collected by means of a funnel and removed from the filter.

For the production of elastic filter fabrics or elastic fabrics that are known so far textured, i.e. crimped multifilament threads are used. However, such fabrics consisting of multifilament threads have a number of disadvantages. On account of the very large surface of crimped multifilament threads the inclusion of small particles into the fabric structure is fostered, which leads to a gradual clogging of the filter fabric and thus to a gradual loss in efficiency during the operation.

Moreover, included particles also cause a deterioration of e elastic properties of the filter fabric. In addition, a filter fabric consisting of a plurality of fine individual fibres in textured threads has poor abrasive properties by nature, since mechanical influences may lead very quickly to a damage of the very fine threads. Finally, the very strong structuring of the fabric surfaces resulting from the textured multifilament threads brings about a very strong adherence of the filter cake to the fabric surface.

The object of the invention is to provide a filter cloth and a filter bag, in which a filter cake can be detached or removed in a particularly simple and gentle manner, which are particularly easy to clean and in addition have a particularly long service life.

This object is solved by a filter cloth having the features of claim 1 and by a filter bag according to claim 9.

Preferred embodiments of the filter cloth are claimed in the subclaims.

A filter cloth of the above-stated type is improved according to the invention in that an extensible fabric structure is provided at least in the filtration area in order to raise the filtration area from the supporting surface and that highly elastic monofilament threads are selectively incorporated into the fabric structure at least in the filtration area in order to produce a defined amount of elasticity.

A basic idea of the invention may be seen in the fact that highly elastic monofilament threads are incorporated into at least a portion of the filter cloth so that in this fabric portion a specific desired amount of elasticity and consequently a desired behaviour of the filter cloth, in particular a strong extension, is given when introducing a blast of compressed air into the particular cavity of a disk filter segment.

Due to the fact that the monofilament threads have very smooth surfaces the adherence to the filter cake is reduced appreciably in the filter cloth according to the invention, from which follow altogether excellent cake removing properties. Furthermore, on account of the very smooth surface of the monofilament threads the inclusion of small particles in the fabric structure is reduced considerably so that monofilament fabrics show a distinctly lower clogging tendency and in addition they can be cleaned and/or de-clogged better. When introducing the reverse blast of air for the removal of the cake for example, i.e. when introducing a blast of compressed air, remaining amounts of fine particles that are present in the filter fabric can also be blown off at the same time.

Another fundamental advantage of the filter cloth according to the invention may be seen in the fact that monofilament elastic fabrics have a significantly lower elastic fatigue than multifilament elastic fabrics. This means that monofilament elastic fabrics retain their form-recovering properties over a longer period of time and that fabric deformations resulting from permanent overextensions can be avoided. Thus, a wrinkling of the fabric and consequently a premature breakage of the fabric can be prevented.

Finally, with respect to the abrasive resistance the filter cloth according to the invention also shows significant improvements in comparison to fabrics consisting of multifilament elastic threads.

In an advantageous embodiment of the invention the fabric structure is designed in an inflatable manner in the filtration area. In particular a balloon-like inflation can be provided. Here the detachment of the filter cake is not only effected by the exhaust air but also by the considerable extension of the filter cake surface. The extension can be chosen to range between 2% and 80%, with this extension being greater than that of the filter cake. Through this a tearing up and a detaching of the filter cake is fostered. Furthermore, an additional self-cleaning of the filter cloth can be achieved as a result of a balloon effect, the cause of this self-cleaning effect being a fulling process that takes place between adjoining threads in the filter cloth, i.e. a relative movement of adjoining threads. Through this especially the solid particles that accumulate on the crossing points of the threads are detached and stripped off.

To this end it is particularly advantageous that the fabric structure has at least one further thread with a low elasticity and that during the inflation a defined relative movement takes place between the threads of different elasticity. The use of threads that have a different elasticity inevitably results in comparatively great relative movements between the fibres, whereby the self-cleaning effect of the filter cloth is intensified. By preference, the ratio of elasticity of the different threads is 2 to 1 and higher.

The highly elastic monofilament thread is preferably made of polyester, polyurethane, polyolefins, polyamides and/or their copolymers, in particular copolyether-ester. As far as especially copolyether-ester is concerned this is a synthetic copolymer which has excellent properties with regard to strength, elongation at break, knot strength and especially with regard to elastic endurance for being used in a filter cloth in accordance with the invention.

In a further embodiment the fabric structure also has elastic and/or regular non-elastic multifilament and/or quasi-multifilament threads in addition to monofilament threads. By choosing the individual threads the filtration properties of the filter cloth can be changed selectively. However in order to obtain a fabric with good abrasive properties it may be advantageous to design the fabric structure in this case in such a way that at least one surface of the filter cloth is constituted in a substantially complete manner by monofilament threads.

In the case of applications which show an increased tendency to fabric clogging, for instance in suspensions containing a high proportion of very small particles, a filter cloth is preferred that is designed in its entirety of monofilament threads. Here the fabric structure may be designed completely of highly elastic monofilament threads or it may also consist to a certain degree of regular, non-elastic monofilament threads in addition to the elastic monofilament threads.

In a particularly simple embodiment of the invention the warps of the fabric structure consist of a highly elastic monofilament thread and the wefts consist of a regular non-elastic thread. A filter cloth of such type has a strong directional elasticity which is of advantage in the use as a filter band for example.

The fabrics are preferably produced in twill and/or satin weaves, wherein highly elastic monofilament threads can be used in the warp and/or weft direction.

If specific mechanical properties of the filter cloth and/or specific filtration properties are required, double and multilayer fabrics in various fabric textures are also possible. In combining elastic and regular monofilament threads in all fabric directions and/or alternately in a particular direction any chosen elasticity profile can be produced.

Finally, considerably improved removing properties of the filter cloth for the filter cake can be achieved in that a surface of the filter cloth, in particular the surface of a side directed towards a filter cake, is calendered and/or provided with a coating for refining the surface. In addition, the monofilament threads can also be provided with an additional anti-adhesive coating.

The object set out above is solved with regard to the filter bag by a filter bag for disk filters, which is produced of a filter cloth according to the invention.

As far as the filter bag according to the invention is concerned in particular the advantage of the balloon effect and the related fulling effect is of importance, with these effects being intensified to a great extent by the use of highly elastic monofilament threads according to the invention. With these highly elastic monofilament threads very great extensions can already be achieved whilst applying little force so that for instance great surface extensions can be achieved with small blasts of compressed air. For example in the filter bag according to the invention surface extensions amounting to ΔA/A≧0.02 are possible. The bag is fabricated in a disk-segment shaped manner. On account of the elastic material the narrow opening at the bottom of the bag can be pulled onto the segment frame whilst still resting properly on the supporting surface.

By preference, the invention can be applied to filters employed for a cake-forming filtration, in which a device for blowing off the filter cake from the rear of the filtration area is provided.

1. Filter cloth for a filter, which has a supporting surface, comprising a fixing area for attachment to the filter and a filtration area for resting on the supporting surface,
characterized in that
an extensible fabric structure is provided at least in the filtration area to raise the filtration area from the supporting surface and
in that highly elastic monofilament threads are incorporated selectively into the fabric structure at least in the filtration area to produce a defined amount of elasticity.

2. Filter cloth according to claim 1,
characterized in that
the filtration area is designed in an inflatable manner, the extension being greater than that of an accumulated filter cake.

3. Filter cloth according to any one of claims 1 or 2,
characterized in that
the fabric structure has at least one further thread with a low elasticity so that during the inflation a defined relative movement occurs between the threads of different elasticity.

4. Filter cloth according to any one of claims 1 to 3,
characterized in that
the highly elastic monofilament thread is produced of polyester, polyurethane, polyolefins, polyamides and/or their copolymers, in particular copolyether-ester.

5. Filter cloth according to any one of claims 1 to 4,
characterized in that
in addition to monofilament threads the fabric structure also has elastic and/or regular non-elastic multifilament and/or quasi-multifilament threads.

6. Filter cloth according to any one of claims 1 to 3 or 5,
characterized in that
the warps of the fabric structure consist of a highly elastic monofilament thread and the wefts consist of a regular non-elastic thread.

7. Filter cloth according to any one of claims 1 to 6,
characterized in that
a surface of the filter cloth, in particular the surface of a side facing towards a filter cake, is calendered and/or provided with a coating for the refinement of the surface.

8. Filter cloth according to any one of claims 1 to 7,
characterized in that
the fabric structure has twill and/or satin weaves.

9. Filter bag for disk filters, which is produced from a filter cloth according to any one of claims 1 to 8.

10. Filter cloth for a filter cake forming filtration with a filtration area, which has an extensible fabric structure with a highly elastic monofilament thread,
characterized in that
the fabric structure has at least one further thread with an elasticity that is lower than that of the highly elastic monofilament thread,
that the fabric structure consisting of the highly elastic monofilament thread and the further thread is designed with a defined amount of elasticity, which permits a greater extension than that of the formed filter cake, and
in that the elasticity of the highly elastic monofilament thread and of the at least one further thread is selected to be different in such a manner that during the extension a defined relative movement occurs between the threads of different elasticity.
